(19) United States
(12) Patent Application Publication
(10) Pub. No.: US 2025/0028300 A1
(43) Pub. Date: Jan. 23, 2025

(54) CONTROL OF AN INDUSTRIAL ROBOT FOR A GRIPPING TASK

(71) Applicant: Vathos GMBH, Duesseldorf (DE)

(72) Inventor: Jonathan Balzer, Duesseldorf (DE)

(73) Assignee: Vathos GMBH, Duesseldorf (DE)

(21) Appl. No.: 18/707,243

(22) PCT Filed: Nov. 2, 2022
(86) PCT No.: PCT/EP2022/080483

§ 371 Date: May 3, 2024

(30) Foreign Application Priority Data
Nov. 4, 2021 (EP) 21206501.5

(51) Int. Cl. G05B 19/4155; B25J 9/16; G05B 13/02

(52) U.S. Cl. CPC G05B 19/4155; B25J 9/163; G05B 13/027; G05B 2219/39271; G05B 2219/40269

(57) ABSTRACT

In one aspect, the present invention relates to a distributed system for controlling at least one robot (R) in a gripping task for gripping objects (O) of different types which are arranged in a working area (CB, B, T) of the robot (R). The system comprises a central training computer (CTR), which is designed for pre- and post-training, and at least one local processing unit (LCU), on which real image data of the object (O) is recorded, which is used to generate post-training data.

The present invention comprises a distributed at least partially computer-implemented system for controlling at least one robot for gripping objects of different types, a method for operating such a system, a central training computer, a method for operating a central training computer, a local computing unit, a method for operating the local computing unit, and a computer program.

In manufacturing systems, workpieces, tools and/or other objects must be manipulated and moved from one place to another. Fully automated industrial robots are used for this purpose. The robot must therefore recognize the components or objects in its work area and move them from their current location to a target location. To do this, the objects must be gripped. A variety of gripping tools or grippers known in the state of the art are available for solving a gripping task, such as vacuum suction cups, inductive grippers, finger grippers, etc. Depending on the type of object to be gripped, the right type of gripping tools must be determined in order to solve the gripping task. For example, gripping an M6 screw with a length of 20 mm requires a different gripper than a 800×800 mm sheet metal plate.

One problem with prior-art systems of the type mentioned above is that often, the objects to be gripped are not arranged systematically but can be distributed randomly—for example in a box. This makes the gripping task more difficult.

If, for example, an industrial robot has the task of removing parts from a box fully automatically, the parts are usually arranged chaotically within the box in practice and may not be sorted by type. The removed parts should be sorted and placed in an orderly manner on a conveyor belt/pallet or similar for further processing. Alternatively, they are to be loaded into a production machine. A precise grip requires an equally precise estimate of the position and orientation (possibly also “recognition” of the type) of the objects on the basis of images from a 3D camera, which can be mounted at the end of the robot arm or above the box.

Until the advent of data-driven methods, the recognition of objects in images was based on manually designed features. A feature is defined as a transformation of the raw image data into a low-dimensional space. The design of such a feature map aims to reduce the search space by filtering out irrelevant content and noise. For example, the method described in the paper Lowe, D. G. Distinctive Image Features from Scale-Invariant Keypoints, International Journal of Computer Vision 60, 91-110 (2004) is invariant to scaling of the image, because for the recognition of an object it is initially irrelevant at what distance it is from the camera. Such manually designed features are qualitatively and quantitatively strongly tailored to specific object classes and environmental conditions. Optimizing them for a specific application requires expert knowledge and therefore severely restricts the user's flexibility.

Machine learning methods (so-called “artificial intelligence”), on the other hand, are generic in the sense that they can be trained on any object classes and environmental conditions by simply providing a sufficient number of sample images that reflect these environmental conditions. The acquisition and labeling of such training data can also be performed by laypersons without any deeper understanding of what comprises an optimal feature. In particular, so-called deep learning methods learn not only the ability to recognize objects based on their features, but also the optimal structure of the feature itself. What existing methods have in common is that they train exclusively on real data (images of the objects to be recognized). The disadvantage of these methods is that annotated training data of the object type to be grasped must be provided, which is time-consuming and labor-intensive to obtain.

Furthermore, machine learning methods are known in which the training data is not obtained from real images but is generated synthetically. Synthetically generated training data, however, is not accurate enough for the relevant grasping task here due to the lack of realism of the simulation (the so-called “reality gap” [Tremblay et al. 2018b]). Techniques such as the randomization of individual aspects of the simulated imaging process are generic and only inadequately reproduce the actual environmental conditions in individual cases, as explained for example in [Kleeberger and Huber 2020b].

Based on the aforementioned prior art, the present invention has set itself the task of demonstrating a way in which the task of gripping objects in unknown position in an industrial (e.g., manufacturing) process can be improved in terms of accuracy and flexibility. The effort required to train the system is also to be minimized

This object is solved by the enclosed independent patent claims, in particular by a distributed, at least partially computer-implemented system for controlling at least one robot in gripping objects of different types, a method for operating such a system, a central training computer, a method for operating a central training computer, a local computing unit, a method for operating the local computing unit, and a computer program. Further embodiments, features, and/or advantages are described in the sub-claims and in the following description of the invention.

First, the present invention comprises a distributed at least partially computer-implemented system for controlling at least one robot in gripping objects of different types (e.g. screws, workpieces of different shapes and/or sizes, or packages with or without contents, and/or of components of a production system) arranged randomly in the working area of the robot. In particular:
A central training computer outfit with persistent storage in which an instance of an artificial neural network (ANN) is stored, and which is responsible for pre-training and post-training the neural network; wherein the ANN is trained to perform object recognition and position estimation, including estimation of the orientation of the object, to calculate from that instructions executed by the end effector unit of a robot in order to grasp the object; wherein the central training computer is designed to train a dedicated object type, and wherein the central training computer is designed to perform pre-training exclusively with synthetically generated object data serving as pre-training data, which is generated using a geometric 3D model specific to the object type, and wherein, as a result of the pre-training, pre-training parameters of a pre-trained ANN are transmitted via a network interface to at least one local computing unit, and wherein the central training computer is further designed to continuously and cyclically perform a post-training of the ANN and, as a result of the post-training, to transmit post-training parameters of a post-trained ANN via the network interface to at least one local computing unit;
A set of local resources interacting over a local network:
   the robot with a robot controller, a manipulator, and the end effector unit, wherein the robot controller is intended to control the robot and in particular its end effector unit for executing the gripping task for one object of the respective object type in each case;
   an optical device used to capture image data of objects in the robot's working area;
   at least one local computing unit for interacting with the robot controller, storing different instances of the ANN, receiving pre-training and post-training parameters from the central training computer, and, in particular, evaluating a pre-trained ANN which is continuously and cyclically replaced by a post-trained ANN until a convergence criterion is satisfied, and
   wherein the pre-trained or post-trained ANN is evaluated in an inference phase on the local computing unit determining a result data set from the image data captured by the optical capture device, which is then used to calculate the instructions for the end effector unit to grasp the object and transmit them to the robot controller for execution;
   wherein a modified ICP algorithm (ICP for “iterative closest point”) is executed on the local computing unit, which evaluates and compares, firstly, the image data acquired by the optical device and, secondly, a reference image to generate a refined result data set, wherein the reference image data is a (synthesized or) rendered image which is rendered based on the the result data set determined by the ANN and a 3D model of the object;
   and whereby the captured image and the refined result data set serve as the post-training data set and are transmitted to the central training computer for the purpose of post-training (and for generating the post-training parameter);
The network interface for data exchange between the central training computer and the set of local computing units, with data exchange taking place via an asynchronous protocol.

The neural network is trained in a supervised manner. The neural network is trained to understand the spatial arrangement (the “state”) of some objects to be gripped (next to each other or partially on top of each other, superimposed, in a box or on a conveyor belt, etc.) so that the system can react by calculating gripping instructions that are specific to the detected state. The state is characterized by the class/type of the respective objects (object identification), their position (position estimation), their orientation (orientation estimation) relative to coordinate system inside the working area of the robot. The system or method enables six-dimensional position and orientation estimation of general objects in space and, in particular, the robot's workspace, which can be of different shapes (conveyor belt, crate, etc.). Post-training is carried out continuously and cyclically on the basis of real image data of the objects to be gripped. The initial training or pre-training is carried out exclusively on the basis of synthetic pre-training data, which is generated from the 3D model of the specific object type using computer graphics methods (in particular a synthesis algorithm). Communication between the central training computer and the at least one local computing unit takes place by means of asynchronous synchronization. Several instances of the neural network are provided and implemented, which are characterized by different training states (pre-trained network, post-trained network in different instances).

The pre-trained neural network (or network for short) allows objects or parts to be recognized on the basis of real image data in a simple environment (flat surface) that is less demanding than the target environment (box). The robot can thus already interact with the object by placing it in different positions and orientations or even carry out the placement phase of the target process. Additional training data, the post-training data, is obtained, but this time under realistic conditions. This data is transferred back to the central training computer via the network interface, in particular the WAN.

The training is continuously improved, taking into account the real image data, by means of post-training, which is carried out on the central training computer, and the result of the post-training (i.e., the weights of the ANN) is transferred back to the local computing unit connected to the robot for the final application (e.g., reaching into the box).

The solution described here exhibits all the advantages of a data-driven object recognition approach, such as high reliability and flexibility through simple programming and/or parameterization, but at the same time without any effort for the generation of training data and without any loss of accuracy due to the discrepancy between synthetically generated training data and the real application environment.

The neural network can be stored and/or implemented and/or applied in different instances, in particular on the local computing unit. “Instance” here refers to the training state. A first instance could, for example, be a pre-trained state, a second instance a first post-trained state, a third instance a second post-trained state, whereby the post-training data is always generated on the basis of real image data captured with the optical capture device and the pre-training data is based exclusively on synthetically generated object data (which is also rendered and is therefore also image data). The instance is represented in the weights of the ANN (a.k.a. pre- and post-training parameters), which are transferred from the central training computer to the local computing units after each training session.

The gripping instructions comprise at least a set of target positions for the set of end effectors used to perform the gripping task. The gripping instructions can also include a time specification of when which end effector must be activated in synchronization with which other end effector(s) in order to perform the gripping task, e.g., in joint holding with 2-finger or multi-finger grippers.

The 3D model is a three-dimensional model that characterizes the surface of the respective object type. It can be a CAD model. The format of the 3D model is selectable and can be converted by a conversion algorithm, e.g., into a triangle mesh in OBJ format, in which the surface of the object is approximated by a set of triangles. The 3D model has an (intrinsic) coordinate system. The render engine, which is installed on the central training computer, can position the intrinsic coordinate system of the 3D model in relation to a coordinate system of a virtual camera. The 3D model is positioned in a pure simulation environment on the central training computer so that a depth image can be synthesized by the render engine based on this positioning. The image generated in this way (object data) is then assigned the orientation and/or position of the object depicted in it as a label.

Here, object type means a product type, i.e., an identifier of the application (i.e., specifically which object should be gripped). With this object type information, the central training computer can access the database of 3D models in order to load the appropriate object type-specific 3D model, e.g., for screws of a certain type, the 3D model of this screw type. In particular, the loaded 3D model is brought into all physically plausible or physically possible positions and/or orientations by a so-called render engine (electronic module on the central training computer). Preferably, a render engine is implemented on the central training computer. A synthesis algorithm takes into account the geometric boundary conditions of the object, such as size, center of gravity, mass and/or degrees of freedom, etc. An image is then rendered and a depth buffer is stored as a synthesized data object together with the labels (position and orientation, optionally the class) of the object depicted in the image (quasi as a synthesized image). The synthesized images serve as pre-training data used to pre-train the neural network on the central training computer.

The pre-training data is thus generated in an automatic, algorithmic process (synthesis algorithm) from the 3D model that matches the specific object type or is specific to the object type and is stored in a model store. This means that no real image data of the objects to be grasped needs to be captured and transferred to the central training computer for pre-training. The pre-training can therefore be carried out autonomously on the central training computer. The pre-training data is exclusively object data that has been synthesized using the synthesis algorithm.

Post-training is used to retrain or improve the machine learning model with real image data that has been captured on the local computing unit from real objects in the robot's workspace. The post-training data is annotated or labeled using an annotation algorithm based on generated reference image data. The post-training data is therefore in particular annotated image data based on real image data that has been captured locally with the optical capture device. For post-training, the weights of the ANN from the pre-training are loaded first. Based on this, a stochastic gradient descent procedure is continued using the post-training data. The error functional and the gradient are calculated using the set of all training data points. The size and properties of the input data influence the position of the global minimum and thus also the weights (or parameters) of the ANN. In particular, where RGB images exist, six (6) coordinates (position of the point and 3 color channels) are fed into the input layer of the ANN. Otherwise, three (3) coordinates are fed into the input layer of the ANN.

Post-training takes place cyclically. Post-training data based on real image data is continuously recorded during operation. The more real image data and therefore post-training data is available, the less synthetic data (object data) the process requires. The ratio of synthetic data to real image data is continuously reduced until no more synthetic data is available in the post-training data set.

After completion of the pre-training and/or post-training on the central training computer, pre-training parameters and/or post-training parameters with weights are generated for the neural network (existing weights can be retained or adapted during post-training). An important technical advantage is that only the weights in the form of the pre-training parameters and/or post-training parameters need to be transmitted from the central training computer to the local computing unit, which results in transmission in compressed form and helps to save network resources.

The end effector unit can be arranged on a manipulator of the robot, which can be designed as a robot arm, for example, to carry the end effectors. Manipulators with different kinematics are possible (6-axis robot with 6 degrees of freedom, linear unit with only 3 translational degrees of freedom, etc.). The end effector unit can comprise several different end effectors. An end effector can, for example, be designed as a vacuum suction cup or a pneumatic gripper. Alternatively or cumulatively, magnetic, mechanical and/or adhesive grippers can be used. Several end effectors can also be activated simultaneously to perform a coordinated gripping task. The end effector unit can comprise one or more end effectors, such as 2- or 3-finger grippers and/or suction cup grippers.

The local computing unit can be designed as an edge device, for example. The artificial neural network (ANN) and/or the software with the algorithms (e.g., modified ICP, automatic method for labeling the camera images, etc.) can be provided with the hardware as an embedded device.

The local computing unit is designed to interact with the robot controller, in particular to exchange data with the robot controller. In this respect, the local computing unit controls the robot at least indirectly by instructing the robot controller accordingly. The local resources thus comprise two different controllers: on the one hand, the robot controller (on the industrial robot) and, on the other hand, the local computing unit, in particular an edge device, which is set up in particular to evaluate the captured images. The robot controller queries the position of the objects from the local computing unit in order to then “control” the robot. In this respect, the robot controller has control over the local computing unit. The edge device controls the robot indirectly.

The modified ICP algorithm is primarily used to provide annotations of the result data from the neural network and enables an external evaluation of this result. The modification of the classic ICP algorithm is that not only the correspondences (in the form of nearest neighbors) are recalculated between the iterations of the algorithm, but also one of the two compared point clouds by rendering a depth image of the model from the currently estimated relative position/orientation of model and camera. The error measure to be minimized is calculated from the distances of corresponding points in space, whereby the correspondences in each iteration are also determined on the basis of the shortest distances. The chicken-and-egg problem is solved by iterative execution (similar to the concept of iterative training described here).

During inference, a result data set with the labels is determined from the captured image data in which the object to be gripped is depicted, in particular the position and orientation of the object in the working area and optionally the class. The result data set is an intermediate result.

The modified ICP algorithm is applied to the result data set in order to calculate a refined result data set that serves as the final result. The final result is transmitted to the robot controller on the one hand and to the central training computer on the other for the purpose of post-training.

In the context of the invention, a “computing unit” or a “computer” can be understood, for example, as a machine or an electronic circuit. The method is then executed in an “embedded” fashion. In particular, the local operating method can be closely coupled with the robot controller. In particular, a processor may be a central processing unit (CPU), a microprocessor or a microcontroller, for example an application-specific integrated circuit or a digital signal processor, possibly in combination with a memory unit for storing program instructions, etc. A processor can also be an IC (integrated circuit), for example, in particular an FPGA (field programmable gate array) or an ASIC (application-specific integrated circuit), or e.g., a multi-chip module, e.g., a 2.5D or 3D multi-chip module, in which in particular several dies are connected directly or via an interposer, or a DSP (Digital Signal Processor) or a GPU (Graphic Processing Unit). A processor can also be a virtualized processor, a virtual machine or a soft CPU. For example, it can also be a programmable processor that is equipped with configuration steps for executing the method according to the invention or is configured with configuration steps in such a way that the programmable processor implements the features of the method, the component, the modules or other aspects and/or sub-aspects of the invention.

The term “result data set” or “refined result data set” refers to a data set in which labels, i.e., in particular the position and/or orientation or position and optionally the object type (e.g., screw, workpiece plate) of the object is coded. The gripping instructions can be calculated on the basis of the (refined) result data set.

The gripping instructions are essentially calculated using a series of coordinate transformations: grip=transformation matrix from gripper to object coordinates F_{GO}, object position/orientation=transformation from object to robot coordinates F_{OR}. The transformation from gripper to robot coordinates F_{GR}=F_{GO}*F_{OR}, where G represents the gripper, O the object, R the robot coordinates, is sought.

Gripping instructions can be processed by the robot controller in order to control the robot with its end effectors to execute the object type-specific gripping task. To do this, the (refined) result data set must be “combined” with a grip or gripping positions. The grip for the respective object is transferred as a data set from the central training computer to the local computing unit. The grip encodes the intended relative position and/or orientation of the gripper relative to the object to be grasped. This relationship (position/orientation of gripper-position/orientation of object) is calculated independently of the position and/or orientation of the object in space (coordinate transformation).

In a preferred embodiment of the invention, the local computing unit “only” calculates the target position and/or orientation of the end effector, i.e., the combination of grip and object position, and transfers that to the robot controller. The robot controller calculates a path to bring the end effector from the current state to the target state and converts this into axis angles using inverse kinematics.

In a preferred embodiment of the invention, the network interface serves to transmit parameters (weights), in particular pre-training parameters and/or post-training parameters for instantiating the pre-trained or post-trained ANN from the central computer to the at least one local computing unit. Alternatively or cumulatively, the network interface can be used to transmit the refined result data set generated on the at least one local computing unit as a post-training data set to the central training computer for post-training. Alternatively or cumulatively, the network interface can be used to load the geometric, object-type-specific 3D model on the local computing unit. This can be triggered via the user interface, e.g., by selecting a specific object type. The 3D model, e.g., a CAD model, can be loaded from a model store or from the central training computer.

In a further preferred embodiment of the invention, labeled or annotated post-training data can be generated on the local computing unit from the image data captured locally with the optical acquisition device and fed to the ANN for evaluation and the synthesized reference image data in an automatic process, namely an annotation algorithm, which is transmitted to the central training computer for the purpose of post-training. The modified ICP algorithm compensates for the weaknesses of the (only) pre-trained network by utilizing strong geometric constraints. The real and locally captured images are transmitted to the central training computer together with the refined detections (refined result data set=result of the modified ICP algorithm=labels).

In a further preferred embodiment of the invention, the system has a user interface. The user interface can be designed as an application (app) and/or as a web interface, which via an API exchanges all data relevant to the method between the central training computer and the human operator. In particular, the 3D model is first transferred and stored in the model storage. The user interface is intended to provide at least one selection field in order to determine an object type of the objects to be gripped. This can be evaluated as a trigger signal to transmit the specified object type to the central training computer, so that the central training computer loads the object-type-specific 3D model from a model storage in response to the specified object type in order to synthesize object-type-specific images in all physically plausible positions and/or orientations by means of a synthesis algorithm, which serve as the basis for pre-training the neural network. The synthesis algorithm processes mechanical and/or physical data of the object type such as center of gravity, size and/or stable position data in order to render only physically plausible positions and/or orientations of the object. This means that only the object data that represents the object in physically possible positions should be rendered. Physically possible positions are in particular the calculated stable positions. An unstable position (e.g., a screw is never encountered standing on its tip) is not rendered. This has the advantage that computing capacity can be saved and unnecessary data storage and data processing can be avoided.

The neural network is trained to output from at least one (depth) image (cumulatively, an RGB image) of an object, the position of the object in the coordinate system of the robot's working area, including the orientation of the object, and optionally a recognition of the object class/type as a result data set. Preferably, the neural network can be additionally trained to provide a reliability of the output in the form of a reliability data set. The neural network can be designed as a deep neural network (DNN). The neural network can be understood as a function approximation/regression:

$$f ( image ) = position / orientation / optional : class ( label ) ,$$

where f(image) is uniquely defined by the parameters/weights of the network, so there is an implicit dependency on the parameters, i.e., f=f (image; parameter). Training means nothing more than minimizing a certain loss function over the set of parameters/weights:

$$Parameter = arg min loss ( f ( {Image}_{Known} ) - {Label}_{Known} ) ) ,$$

so that you can later use f to get a meaningful output label_{unknown} for an input image_{unknown}.

The neural network may have a Votenet architecture. For more details on the Votenet architecture, please refer to the publication C. R. Qi, O. Litany, K. He and L. Guibas, “Deep Hough Voting for 3D Object Detection in Point Clouds,” 2019 IEEE/CVF International Conference on Computer Vision (ICCV), 2019, pp. 9276-9285. In particular, the Votenet architecture comprises three modules: firstly, a backbone for learning local features, secondly, an evaluation module for evaluating and/or accumulating the individual feature vectors, and thirdly, a conversion module intended to convert a result of the accumulation into object detections.

In a further preferred embodiment of the invention, the network interface can be used for synchronization of central and local computers by means of a message broker (e.g., RabbitMQ). The advantage of this solution is that the system can also be used when there is currently no network connection between the local resources and the central training computer. This means that the local computing unit in the local network of the robot can work autonomously and, in particular, independently of the central training computer. Once the parameters for implementing the neural network have been loaded onto the local computing unit, the local computing unit can work fully autonomously.

In a further preferred embodiment of the invention, the data exchange between the local resources and the central training computer can take place exclusively via the local computing unit, which serves as a gateway. The local computing unit therefore acts as a gateway on the one hand, and on the other hand it also carries out all “transactions” because it is the only instance that can “reach” both interaction partners or sides, both the central computing unit and itself or the modules or units of the local resources. The local computing unit or edge device in the local network is generally not accessible for applications in the cloud without additional technical effort (e.g., a VPN).

In a further preferred embodiment of the invention, the gripping instructions may contain a data set used to identify at least one end effector suitable for the object from a set of end effectors.

The gripping instructions generated on the local computing unit “only” contain the target position and/or orientation of the end effector for the grip. The gripping instructions are then further processed on the robot controller in order to calculate a path to bring the end effector from the current state to the target state. The robot controller converts these into axis angles using inverse kinematics. The system can preferably be supplied with so-called “process knowledge”, i.e., data that defines the automated manufacturing process. The process knowledge includes, among other things, the type of gripper to execute the physical grip (a vacuum gripper grips differently than a 2-finger gripper), which is read in before the gripping position and/or orientation is calculated. The process knowledge can be taken in to account in a motion program that runs on the robot controller.

In a further preferred embodiment of the invention, the optical device comprises a device for capturing depth images and optionally for capturing intensity images in the visible or infrared spectrum. The intensity images can preferably be used to verify the depth images. This can improve the quality of the process. The acquisition device for capturing depth images and intensity images can be implemented in a common device. Typically, depth and intensity cameras are integrated in one device. In all common measurement principles, the depth image is calculated from one or more intensity images, e.g., using a fringe projection method.

In a further preferred embodiment of the invention, the calculated grasping instructions can be visualized by showing a virtual scene of the gripper grasping the object, the calculated visualization of the grasping instructions being output on a user interface. The output of the virtualized visualization makes it possible to perform a manual verification, e.g., to avoid incorrect grasps due to an incorrectly determined object type. In particular, in a preferred embodiment of the invention, a visualization of the grip (gripper relative to the object) is implemented so that the reliability of the detection can be checked before commissioning. However, during operation and during the recording of data for post-training, this visualization can be omitted or is optional. The visualization is displayed on a user interface that is connected to the local resources in the robot's environment.

In a further preferred embodiment of the invention, the post-training of the neural network is performed iteratively and cyclically following a transmission of post-training data in the form of refined result data sets comprising image data captured locally by the optical capture device, which are automatically annotated and which have been transmitted from the local computing unit to the central training computer. This means that although the post-training is carried out on the central training computer, the post-training data for this is accumulated on the local computing unit from real image data captured from the real objects in the robot's working area. The post-training thus enables specific post-training for the respective object type. Even if the pre-training was already tied to a specific object type through its 3D model, the objects currently to be gripped may still differ within the object type, e.g., screws may have a different thread and/or a different length.

In a further preferred embodiment of the invention, the post-training data set for retraining the neural network is gradually and continuously expanded by image data acquired locally by sensors aimed at the working area of the robot.

Above the solution to the gripping task was described at hand of the physical system, i.e., a device. Features, advantages, or alternative embodiments mentioned in that description are also applicable to the other claimed subject matters and vice versa. In other words, the method-based claims (which are directed, for example, to a central operating method and to a local method or to a computer program) can also be further developed with the features described or claimed in connection with the system and vice versa. The corresponding functional features of the method are formed by corresponding modules, in particular hardware modules or microprocessor modules, of the system or product and vice versa. The preferred embodiments of the invention described above in connection with the system are not explicitly repeated for the method. In general, in computer science, a software implementation and a corresponding hardware implementation (e.g., as an embedded system) are equivalent. For example, a method step for “storing” data can be performed with a memory unit and corresponding instructions for writing data to the memory. Therefore, to avoid redundancy, the method is not explicitly described again, although it may also be used in the alternative embodiments described with respect to the system.

A further aspect of the invention is a method for operating a system according to any one of the preceding claims, comprising the following method steps:
On the central training computer: reading in an object type;
On the central training computer: Access to a model storage in order to load the 3D model, in particular a CAD model, assigned to the object type recorded and to generate synthetic object data from it, in particular using a synthesis algorithm, and to use it for the purpose of pre-training;
On the central training computer: pre-training of a neural network with the synthetic object data;
On the central training computer: Provision of pre-training parameters;
On the central training computer: Transmission of the pre-training parameters via the network interface to at least one local computing unit;
On the at least one local computing unit: reading in pre-training parameters or post-training parameters of a pre-trained or post-trained ANN via the network interface in order to implement the pre-trained or post-trained ANN;
On the at least one local computing unit: Capturing (real) image data of real objects in the robot's working area;
On the at least one local computing unit: Apply the pre-trained or post-trained ANN with the acquired image data to determine the result dataset;
On the at least one local processing unit: executing a modified ICP algorithm which evaluates and compares as input data, firstly, the image data of the optical acquisition device supplied to the implemented ANN for application and, secondly, reference image data to minimize the errors and to generate a refined result data set, wherein the reference image data is a synthesized and/or rendered image rendered to the result data set determined by the ANN based on the 3D model;
On the at least one local computing unit: calculating gripping instructions for the robot's end effector unit on the basis of the refined result data set generated;
On the at least one local computing unit: Data exchange with the robot controller to instruct the robot controller so that it can control the robot's end effector unit on the basis of the gripping instructions generated;
On the at least one local computing unit: generating post-training data, wherein the refined result data set serves as the post-training data set and is transmitted to the central training computer for the purpose of post-training (and accordingly for generating the post-training parameters). The procedure for generating real training data is as follows:
   1. recording at least one depth image, optionally an intensity image registered with the depth image;
   2. evaluation of the depth image by the ANN. The result is the class of objects, their positions and orientations. The intermediate result is a “detection” of all objects visible in the image.
   3. refinement of the result provided by the ANN using a modified ICP algorithm.
On the central training computer: retrieval of post-training data via the network interface, the post-training data comprising the labeled or annotated real image data acquired with the optical acquisition device;
On the central training computer: Continuous and cyclical retraining of the neural network with the recorded post-training data until a convergence criterion is met;
On the central training computer: Transmission of the post-training parameters via the network interface to at least one local computing unit.

In a further aspect, the invention relates to a method for operating a central training computer in a system as described above. The central operating method corresponds to the system and corresponds to a hardware solution, while the method represents the software implementation. The method comprises the following steps:
Reading in an object type;
Loading the 3D model, in particular a CAD model, assigned to the detected object type from model storage and generating synthetic object data from it, in particular using a synthesis algorithm, and using that data for pre-training;
Pre-training of a neural network with the generated synthetic object data to provide pre-training parameters;
Transmitting the pre-training parameters via the network interface to the at least one local computing unit;
Acquisition of post-training data via the network interface, the post-training data comprising a refined result data set based on real image data of objects in the robot's working area captured with the optical acquisition device, which have been annotated in an automatic process on the local computing unit;
Continuous and cyclical retraining of the neural network with the recorded retraining data until a convergence criterion is met;
Transmission of the post-training parameters via the network interface to the at least one local computing unit.

Preferably, the steps of acquiring post-training data, post-training, and transmitting the post-training parameters are carried out iteratively on the basis of newly acquired post-training data. This makes it possible to continuously improve the system or method for object detection and the automatic generation of gripping instructions.

In a further aspect, the invention relates to a method for operating local computing units in a system as described above, comprising the following method steps:
Reading in pre-training parameters or post-training parameters of a pre-trained or post-trained ANN via the network interface in order to implement the pre-trained or post-trained ANN;
Capturing image data of the objects in the work area using the optical acquisition device;
Applying the pre-trained or post-trained ANN to the captured image data to obtain the respective result dataset for the objects depicted in the image;
Executing a modified ICP algorithm which evaluates and compares as input data, firstly, the image data of the optical acquisition device supplied to the implemented ANN for application and, secondly, reference image data to minimize the errors and to generate a refined result data set, wherein the reference image data is a synthesized and image rendered based on the result data set determined by the ANN and the 3D model;
Transmission of the refined result data set to the central training computer;
Calculation of gripping instructions for the robot's end effector unit based on the refined result data set;
Data exchange with the robot controller to control the robot's end effector unit with the generated gripping instructions.

In a preferred embodiment of the invention, in the local operating method just described, the acquisition of the image data is triggered before the gripping instructions for the object are executed. Alternatively, the acquisition of the image data can also be carried out during the gripping of already recognized objects. The final result in the form of the refined result data set is transmitted to the robot or its controller for executing the gripping instructions and transmitted to the central training computer at the same time or with a time delay. The upload of the image data preferably runs in parallel to the primary process (control of the robot). By cleverly assigning identifiers, image data and labels/annotations can later be associated with each other in the central training computer: A unique identification number is generated for each image captured (using the camera). Each label stored in a database table contains a reference to the corresponding image in the form of the image ID.

For example, the objects can be arranged in the training phase without any restrictions, in particular, in a box and partially occluding each other, from which they are to be gripped using the end effectors. With each grasp, image data is captured and used as training data. The training data is thus generated automatically in this method.

In a preferred embodiment of the invention, when using the pre-trained ANN in a pre-training phase, the objects can be arranged adhering to certain simplifying assumptions, in particular on a plane and disjoint in the working area. In later stages, in particular when using the post-trained ANN, the objects can be arranged in the working area without adhering to any boundary conditions (i.e., in arbitrary possibly unstable orientation, partially occluding each other, etc.).

In a further aspect, the invention relates to a central training computer as described above having a persistent storage on which an instance of a neural network is stored, wherein the training computer is for pre-training and post-training the neural network trained for object recognition and position detection, including detection of an orientation of the object, to calculate grasping instructions for an end effector unit of the robot for grasping the object;
whereby the central training computer is designed to read in an object type and
wherein the central training computer has an interface to a model storage in which a geometric 3D model is stored for each object type, and
wherein the central training computer is designed to perform a pre-training exclusively with synthetically generated object data, which serve as pre-training data, which are generated by means of the geometric, object-type-specific 3D model and wherein, as a result of the pre-training, pre-training parameters of a pre-trained neural network (ANN) are transmitted via a network interface to at least one local computing unit and
wherein the central training computer is further designed to continuously and cyclically perform post-training of the neural network on the basis of post-training data and to transmit post-training parameters of a post-trained ANN to the at least one local computing unit via the network interface as a result of the post-training.

In a further aspect, the invention relates to a local computing unit in a distributed system as described above, wherein the local computing unit is intended for data exchange with a controller of the robot for controlling the robot and in particular its end effector unit for executing the gripping task for one object at a time, and
wherein local computing unit is intended to store different instances of the neural network, in that the local computing unit is intended to receive from the central training computer pre-training parameters and post-training parameters, in particular to implement a pre-trained ANN which is continuously and cyclically replaced by a post-trained ANN until a convergence criterion is met, and
wherein the pre-trained or post-trained ANN is applied in an inference phase by determining a result data set for the image data captured by the optical acquisition device,
and wherein a modified ICP algorithm is executed which evaluates and compares as input data, firstly, the image data of the optical acquisition device supplied to the implemented ANN and, secondly, reference image data to minimize alignment errors and to generate a refined result data set, wherein the reference image data is a synthetic image which is rendered base on the result data set determined by the ANN and the 3D model, and wherein the refined result data set serves as a basis to calculate the grasping instructions for the end effector unit to grasp the object and transmit them to the robot controller of the robot to perform the grasping task.

In a preferred embodiment of the invention, the local processing unit comprises a graphics processing unit (GPU) used to evaluate the neural network.

In a further aspect, the invention relates to a computer program, wherein the computer program is loadable into a memory unit of a computing unit and contains program code portions to cause the computing unit to execute the method as described above when the computer program is executed in the local computing unit. The computing unit may be the central training computer for executing the central operating method or the local computing unit for executing the local operating method.

In a further aspect, the invention relates to a computer program product. The computer program product may be stored on a data carrier or a computer-readable storage medium.

In the following detailed description of the figures, non-limiting examples of embodiments with their features and further advantages are discussed with reference to the drawing.

### BRIEF DESCRIPTION OF THE FIGURES

FIG. 1 an interaction diagram showing the data exchange between the components of a system according to a preferred embodiment of the invention;

FIG. 2 a schematic representation of the data connection between the involved central and local instances;

FIG. 3 a schematic representation of a central training computer in communication with a set of local computing units;

FIG. 4 a further schematic representation of a gripping process of the robot gripping an object with the calculated gripping instructions;

FIG. 5 a further schematic representation of a gripping process of the robot gripping objects in a more complex arrangement in the working area, in particular, in a box;

FIG. 6 a further schematic representation of a gripping process of the robot gripping objects and sorting the gripped objects, in particular when sorting them into a box;

FIG. 7 a flowchart of an operating procedure for execution on a system;

FIG. 8 a flow chart of a central operating procedure for execution on a central training computer;

FIG. 9 a flow chart of a local operating procedure for execution on a local computing unit;

FIG. 10 an exemplary preferred implementation of the neural network as a Votenet architecture;

FIG. 11 schematic representation of a synchronization mechanism for asynchronous message exchange between the central training computer CTC and the respective local computing unit LCU;

FIG. 12 UML diagram showing the operation of the system, especially during inference;

FIG. 13 UML diagram of the training process;

FIG. 14 an exemplary representation of a robot arm with an end effector unit consisting of 4 vacuum grippers and

FIG. 15 an exemplary illustration of a 2-finger gripper.

### DETAILED DESCRIPTION OF THE FIGURES

The invention relates to the computer-implemented control of an industrial robot for gripping objects of different types, such as screws, workpieces, or intermediate products as part of a production process.

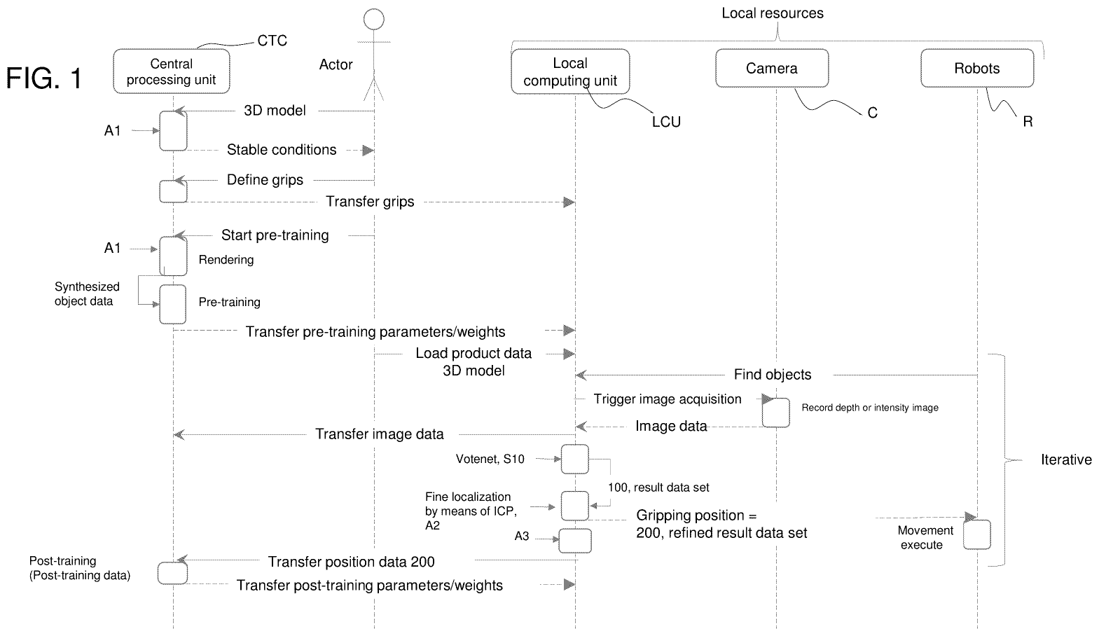

FIG. 1 shows an interaction diagram for data exchange between different electronic units to perform the above-mentioned grasping task. In a preferred embodiment, the system comprises a central training computer CTC and a set of local resources. “Local” here means in the vicinity of the robot, i.e., arranged close on the robot. The local resources can comprise at least one local computing unit LCU, at least one optical detection device C, and a robot R with a robot controller RC.

The local resources exchange data via a local network, in particular a wireless network, for example a radio network. The local resources are connected to the central training computer CTC via a WAN network (Wide Area Network, for example the Internet).

In a preferred embodiment, the system is designed with a user interface UI via which a user, called an actor in FIG. 1, can interact with the system.

The procedure can be triggered by entering a specific object type in the user interface UI (for example, screws). Once this object type data set has been selected by the user interface UI, which can be implemented as a mobile or web application, the object type is transmitted to the central training computer CTC. In response to the selected object type, the appropriate 3D model (for example as a CAD model) is loaded onto the central training computer CTC. A synthesis algorithm A1 can then be executed on the central training computer CTC. in order to synthesize or render images of the loaded 3D model. The synthesis algorithm A1 is designed to bring the images into all positions and/or orientations that are physically plausible. In particular, the center of gravity of the object, its size and/or the respective working area are taken into account. Further technical details on the synthesis algorithm are explained below.

Grips can also be defined in the user interface UI, which are transmitted to the central training computer CTC in the form of a grip data set. After execution of the synthesis algorithm A1, only synthetically generated pre-training data is provided. The pre-training data generated in this way, which is based exclusively on CAD model data for the specific object type, is then used to pre-train an artificial neural network (ANN). After completing the pre-training with the pre-training data, weights of the ANN network can be provided, making it possible to implement the ANN neural network. The weights are transferred to the local computing unit LCU. Furthermore, the 3D model of the specific object type is also loaded on the local computing unit LCU. The pre-trained neural network ANN can then be evaluated on the local computing unit LCU.

An annotation process can then be carried out on the local processing unit LCU on the basis of real image data captured with the optical acquisition device and, in particular, with the camera C. The annotation process is used to generate post-training data, which is transmitted to the central training computer for post-training. The training, pre- or post-training, takes place exclusively on the central training computer. However, the data aggregation for post-training is carried out on the local LCU computing unit.

For this purpose, the following process steps can be executed iteratively on the local resources. The robot controller RC triggers the process by means of an initialization signal that is sent to the local computer unit LCU. The local processing unit LCU then triggers an image acquisition by the camera C. The camera C is preferably set up so that it can capture the working area CB, B, T of the robot R. The camera C can be designed to capture depth images and, if necessary, intensity images. The real image data captured of the object O is transmitted by the camera C to the local processing unit LCU in order to be evaluated there, i.e., on the local processing unit LCU. This is done using the previously trained neural network ANN. After feeding the image data into the neural network ANN, a result data set 100 is output. The result data set 100 is an intermediate result.

After the intermediate result from the neural network ANN can be provided, a modified ICP algorithm A2 is applied for fine localization. The result of the modified ICP algorithm A2 serves as the final result and is represented in a refined result data set 200 and improves or refines the intermediate result that comes from the neural network calculation. The gripping instructions with the specific gripping positions can then be calculated from this refined result data set 200. The gripping instructions can be transferred to the robot controller RC for execution so that it can calculate the movement planning of an end effector unit EE. The robot controller RC can then control the robot R to execute the movement.

The refined result data set 200 comprises annotations for the object O depicted in the image data. The annotations can also be referred to as labels and comprise a location capture data set and an orientation data set and optionally a type or a class of the respective object O.

Parallel to this process, the image data captured by the camera C is transmitted by the local processing unit LCU to the central training computer CTC for the purpose of post-training. Similarly, the final result data with the refined result data set 200 is transmitted from the local computing unit LCU to the central training computer CTC for the purpose of post-training.

The neural network ANN can then be retrained on the central training computer CTC. The retraining is thus based on real image data captured by the camera C, in whic objects O which have been grasped are represented. As a result of the retraining, retraining parameters are provided in the form of modified weights g′. The post-training parameters g′ are transmitted from the central training computer CTC to the local processing unit LCU so that the post-trained neural network ANN can be implemented and applied on the local processing unit LCU.

The process described above “Image acquisition—application of the neural network ANN—execution of the modified ICP algorithm A2—transfer of the image data and execution of the post-training on the central training computer CTC—transfer of post-training parameters g′” can be repeated iteratively or cyclically until a convergence criterion is met and the neural network ANN is optimally adapted to the object to be gripped.

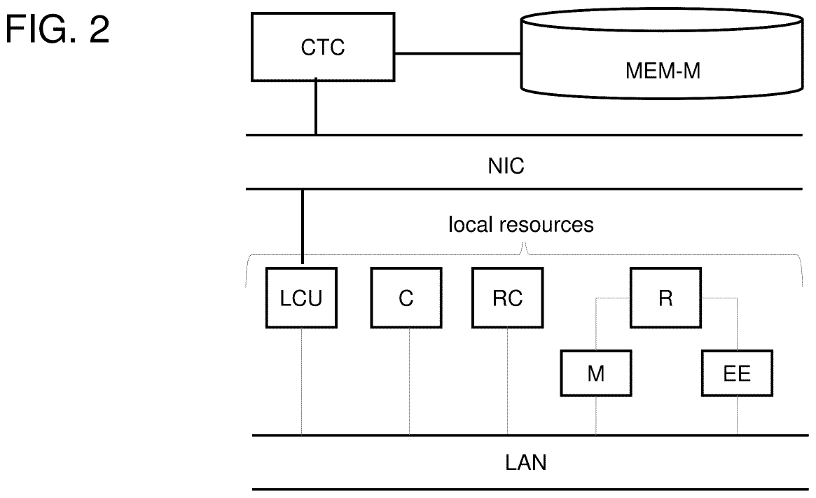

FIG. 2 shows in a further schematic representation the structural arrangement of the electronic components involved according to a preferred embodiment of the invention. The central training computer CTC interacts via a network interface NIC with the local resources comprising the local processing unit LCU, at least one camera C, the robot controller RC and the robot R with a manipulator M and a set of end effectors, such as grippers. The local resources interact via a local area network LAN. In an alternative embodiment of the invention, the robot controller RC can also exchange data with the central training computer directly via the network interface NIC, provided it has an HTTPS client. However, “tunneled” communication via the asynchronous protocol via the local computing unit LCU is preferred. This has the advantage that the system, and therefore production, remains operational, especially if the internet connection is temporarily unavailable or is not available in sufficient quality.

For this reason, communication usually takes place via the local computing unit LCU. It acts as a cache, so to speak, as it can exchange data asynchronously with the central training computer CTC whenever there is a connection. Furthermore, it is easy to run services on the local computing unit LCU that allow each robot controller RC to talk (exchange data) with other instances and thus also with the central training computer CTC or other local resources, not only those that have an HTTP or even HTTPS client. In this advantageous embodiment of the invention, a translation app is installed on the edge device or the local computing unit LCU.

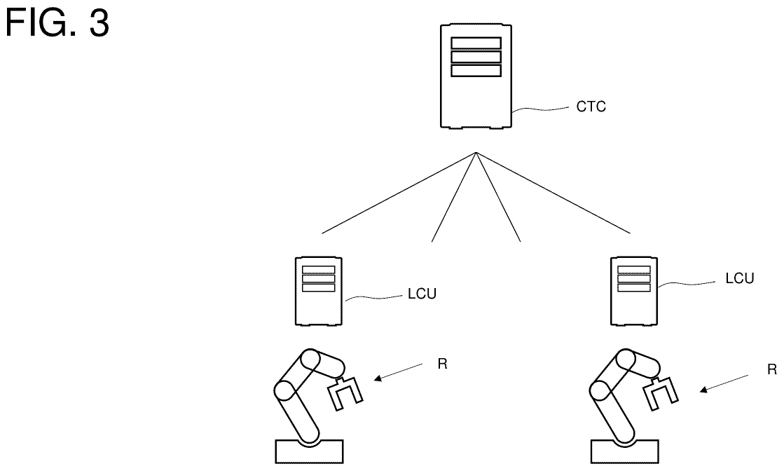

FIG. 3 schematically shows the central training computer CTC, which interacts with the local resources in the local area network (LAN) of the robot R via a WAN, for example.

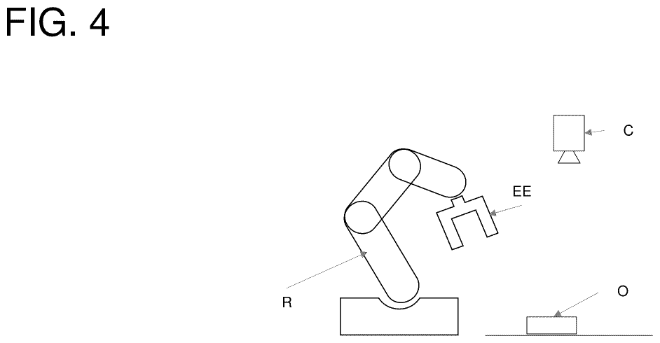

FIG. 4 shows the robot R in a schematic representation with an end effector unit EE, which is also only indicated schematically, and the camera C, which is aligned so that it can see the object O to be gripped in the robot's working area (FoV, field of view).

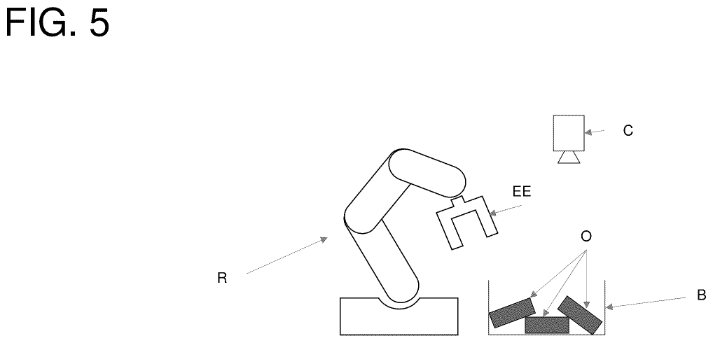

FIG. 5 shows a similar scenario to FIG. 4, except that the objects O are arranged in the working area of the robot R without restrictions, for example, as bulk material in a box. This arrangement of the objects O without restrictions makes object identification and the detection of the position and/or orientation of the object O and thus also the calculation of the gripping instructions more complex.

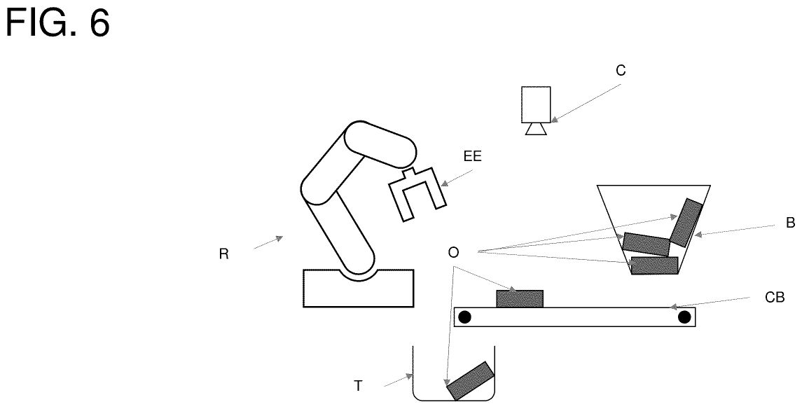

FIG. 6 again shows a similar scenario to that illustrated in FIGS. 4 and 5, with the difference that the objects O can be arranged here in a container B on a schematically illustrated conveyor belt CB and the robot R is instructed to place the objects O in a transport container T.

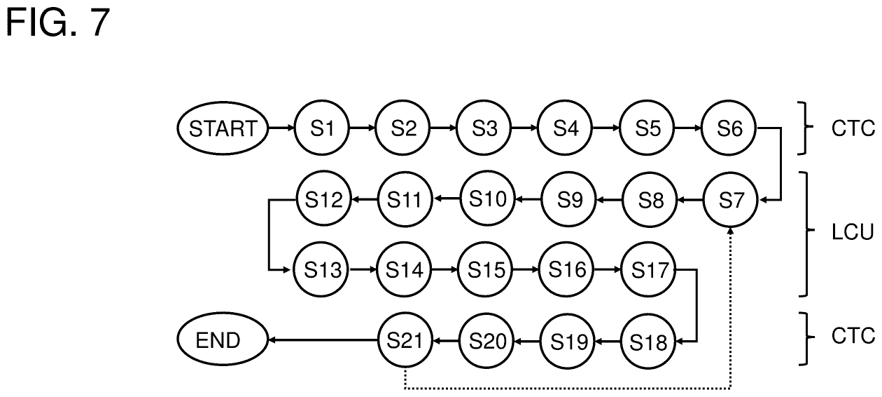

FIG. 7 is a flowchart of a central operating procedure for operating a system as described above. The procedure is executed in a distributed manner and comprises procedural steps that are executed on the central training computer CTC and on the local processing unit LCU.

After starting the procedure, an object type is read in in step S1. This is done on the central training computer CTC. In step S2, a model storage MEM-M is accessed in order to load the 3D model. In step S3, a render engine (renderer) is used to generate synthetic object data or synthesize image data based on the 3D model. Preferably, the synthesis algorithm A1 is used for this purpose. The rendered depth images are saved together with the labels (i.e. in particular position and orientation and optionally class) as a result. In step S4, the pre-training of the neural network ANN is carried out on the basis of the previously generated synthetic object data in order to provide pre-training parameters in step S5. In step S6, the provided pre-training parameters, in the form of weights, are transmitted to the at least one local processing unit LCU.

The following steps are then carried out on the at least one local processing unit LCU: In step S7, the pre- or post-training parameters are read in on the local computing unit LCU.

In step S8, the neural network ANN is then implemented or instantiated using the read-in weights (parameters). In step S9, image data is captured with the camera C, which is fed as input to the currently implemented instance of the neural network ANN in step S10. In step S11, the neural network ANN provides a result data set 100, which can function as an intermediate result. In step S12, a modified ICP algorithm A2 can be applied to the result data set 100 in order to calculate or generate a refined result data set 200 in step S13. In step S14, gripping instructions are calculated from the generated refined result data set 200, which are exchanged with or transmitted to the robot controller RC in step S15. In step S16, post-training data is generated using an annotation algorithm A3. In step S17, the post-training data generated locally on the local computing unit LCU is transmitted to the central computing unit CTC.

The following steps are again carried out on the central processing unit CTC:

In step S18, the transmitted post-training data is recorded in order to carry out post-training in step S19 on the basis of real image data recorded on the local resources, so that post-training parameters can be provided on the central training computer CTC in step S20. These can then be transmitted to the at least one local computing unit LCU in step S21.

This post-training data can then be received and processed on the local computing unit LCU by implementing a post-trained neural network that can then be used with new image data.

The procedure can then iteratively execute the steps related to the retraining until the procedure converges (indicated in FIG. 7 as a dashed arrow pointing back from S21 to S7) or it can otherwise be terminated.

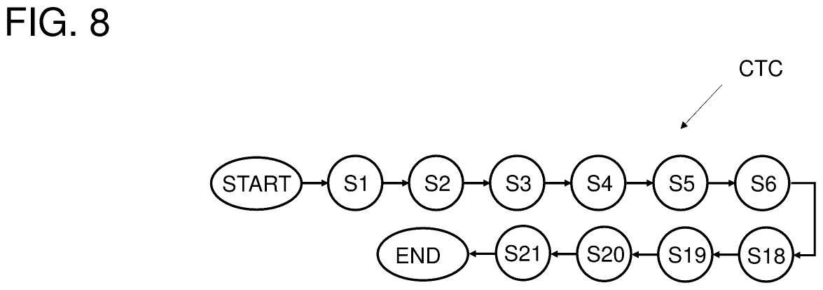

FIG. 8 shows a flowchart for a method that is executed on the central training computer CTC. It relates to steps S1 to S6 and S18 to S21 from the steps described in connection with FIG. 7.

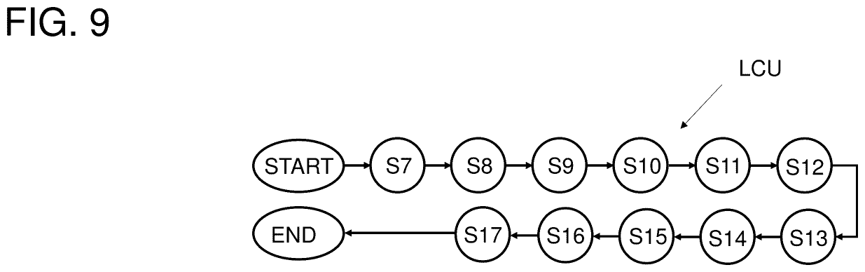

FIG. 9 shows a flow chart for a method that is executed on the local processing unit LCU. It relates to steps S7 to S17 from the steps described in connection with FIG. 7.

The system or method can perform a number of algorithms. First, a synthesis algorithm A1 is applied to synthesize object data in the form of image data. The synthesized object data is generated from the respective object type-specific 3D model. Secondly, a modified ICP algorithm A2 may be used to generate reference (image) data to “score” or annotate the result data generated by applying the neural network. Thirdly, an annotation algorithm A3 can be applied to generate this reference image data. The annotation algorithm A3 is used to generate annotated post-training data. For this purpose, it accesses the result data that is calculated when the neural network is used, namely the labels, in particular with position data, orientation data and, if applicable, class identification data. The 3D model is used to render reference image data to improve the initial pose estimate such that it best matches rendered and captured image data.

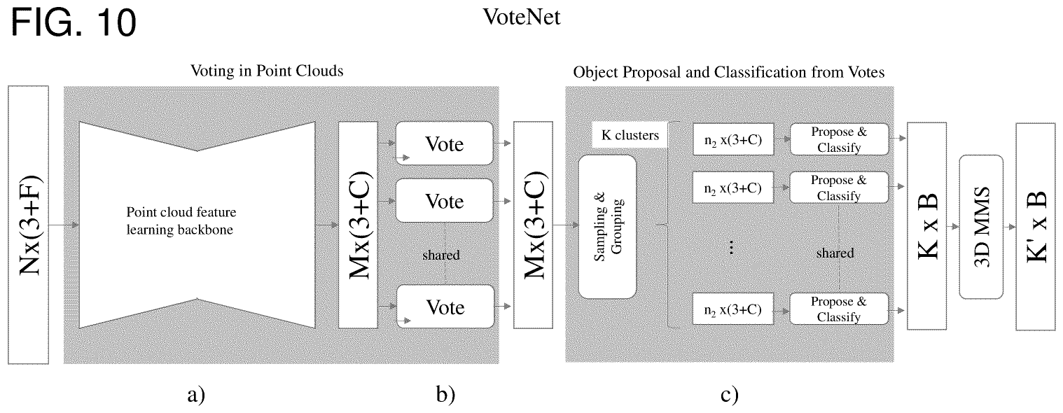

FIG. 10 shows a favored architecture of the ANN neural network. The architecture of the neural network used essentially follows that of Votenet, consisting mainly of three modules:
1. a backbone for learning features, in particular local features coupled with
2. an evaluation module for the evaluation and/or accumulation of individual feature vectors with layers for the interpolation of 3D points,
3. a conversion module that implements a voting mechanism or can also be referred to as a voting module.

In the Votenet architecture, the backbone is used to learn (optimal) local features. In the voting module, each feature vector casts a vote for the presence of an object. The voting module converts the votes from the voting module into object detections. For more details on the Votenet, please refer to the following publication: C. R. Qi, O. Litany, K. He and L. Guibas, “Deep Hough Voting for 3D Object Detection in Point Clouds,” 2019 IEEE/CVF International Conference on Computer Vision (ICCV), 2019, pp. 9276-9285.

The neural network is preferably a deep neural network, DNN. The success of deep neural networks (DNN) for classification/regression is essentially based on the fact that not only the classifier/regressor itself but also the features used for classification/regression are learned. A feature is to be understood as a transformation applied to the raw data with the aim of filtering the disturbances from the raw data (e.g., influences of lighting and viewing angle) while at the same time retaining all information relevant to the task to be solved (e.g., the object position). The feature extraction takes place in the input module of Votenet (FIG. 10a).

The input to the first layer of the network is a point cloud, i.e., a set of points in three-dimensional space. In contrast to a regular grid, over which 2D images are typically defined, this has hardly any topological information: The neighborhood of two points is not immediately clear. However, the calculation of a feature depends on topological information. This is because the gray value of a single pixel may be found hundreds of times in one and the same image and is therefore not very meaningful. Only together with the gray values in its neighborhood can a pixel be clearly distinguished from pixels from other image regions and accordingly—at a higher level of abstraction—objects can be differentiated from the background or other objects. The lack of topological information is compensated for in the backbone by the selection of M seed points, which are chosen so that they cover the point cloud uniformly. A fixed number of points in the neighborhood of each seed point is aggregated and converted into a C-dimensional feature vector using multilayer perceptrons (consisting of convolution operators coupled with a nonlinearity).

The input to the voting module (FIG. 10b) therefore consists of the 3D position of the M seed points and a feature vector. These vote for the presence of an object by moving in the direction of the center of gravity of a possible detection. An accumulation of seed points indicates the actual presence of an object at this position. The number of displacements is modeled by a concatenation of several perceptrons. Shifted M seed points in combination with their feature vectors are now present at the output of the voting module.

In the following evaluation module (FIG. 10c), the result of the voting must be converted into the B desired outputs of the entire network, including the object class, position and orientation of a cuboidal envelope around the object (“bounding box”) and an uncertainty of the respective estimate. Similar sampling and grouping mechanisms are used here as in the backbone, this time applied to the number of seed points and their characteristics: In total, the network can recognize a maximum of K different objects within the input point cloud, i.e., each seed point is assigned to one of K<M cluster centers. A B-dimensional output vector is again calculated from the elements of a cluster with the help of perceptrons.

The values M, N, C, K are so-called hyperparameters and are selected prior to the training. The number and combination of individual layers within the individual modules are optimized for the application at hand. The actual optimization is carried out using stochastic gradient descent. For further details, please refer to Kingma, Diederik P., and Jimmy Ba. “Adam: A method for stochastic optimization.” arXiv preprint arXiv:1412.6980 (2014).

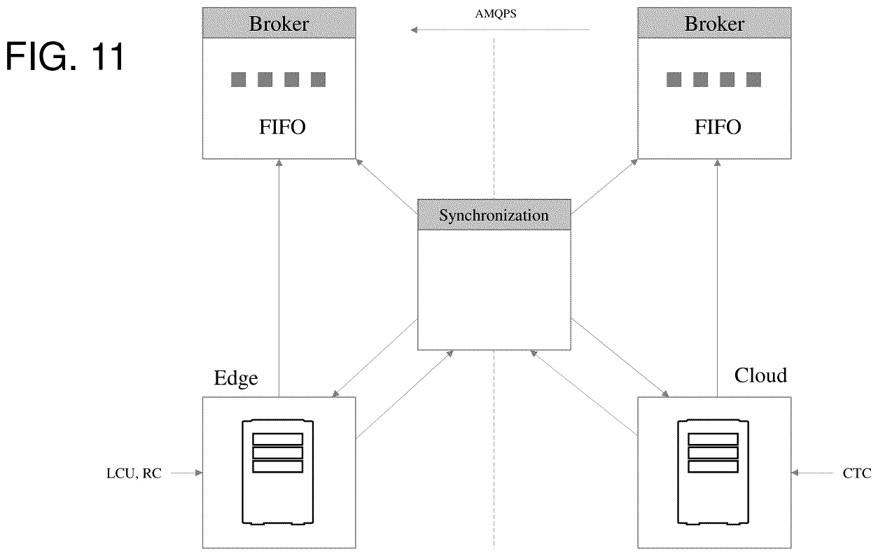

The synchronization or data exchange between the central training computer CTC and the local computing unit LCU is described below with reference to FIG. 11.

The result of the training, pre- and post-training, which is executed exclusively on the central training computer CTC, is a set of values or weights for the parameters of the neural network ANN, which are summarized in a file in compressed form and made available to one or more local computing units LCU via the following general synchronization mechanism: A so-called message broker (e.g. RabbitMQ) is executed on the central training computer CTC and local computing unit LCU, also as a microservice. It provides a FIFO queue (First in First Out) on both sides. This is shown schematically in FIG. 11. Jobs for uploading or downloading can be stored in the queue. A service on the local computing unit LCU processes the first message from both queues as soon as messages are available and there is a network connection to the respective broker. Messages from the queue of the local broker initiate a transfer from the local to the central processing unit (equivalent to the central training computer CTC) and vice versa. After the transfer, the original and the copy of the file are checked for integrity and equality. The message is only deleted from the respective queue once the transfer has been successfully completed. The data exchange is based on an asynchronous communication protocol. This has the advantage that the process can be operated on the local computing unit even if there is no internet connection to the central training computer.

The basic procedure is summarized again below.

The image from the camera C is first fed into the neural network, which optionally outputs the class, but at least the position and orientation of one or more detected objects. The result is usually too imprecise for a reliable grip. For this reason, it is further refined using a modified ICP algorithm or a registration process by comparing the expected and measured depth image (i.e., captured by the camera C). For further technical details on the classic ICP algorithm, please refer to the publication Besl, Paul J., and Neil D. McKay. “Method for registration of 3—D shapes.” In Sensor fusion IV: control paradigms and data structures, vol. 1611, pp., 586-606. International Society for Optics and Photonics, 1992. The robot and camera have a common coordinate system resulting from an initial calibration process (“hand-eye calibration”). This allows the recognized position and orientation of an object together with the desired position and orientation of the gripper relative to the object to be converted into a gripping position and then transferred to the robot controller. The robot controller RC then takes over the planning and execution of the actual grip.

Before operation, the neural network must be trained on the basis of a data set of tuples each consisting of an image and the poses/classes of objects it contains. The parameters of the neural network are optimized using a stochastic gradient descent method in such a way that the deviation between the expected output according to the training data set and the output calculated by the network is minimized. The trained network is a generic model for object recognition, which assigns the position, orientation and class of all the objects contained in an input image in the sense of a black box.

Even for simple object recognition tasks, recording training data is time-consuming and expensive. In the process described here, the training data is generated exclusively synthetically, i.e., by simulation in a computer graphics system. In order to keep the number of images required as low as possible, the synthesis relies on a-priori physical knowledge, such as the stable states in which an object can occur under the influence of gravity or its symmetry properties.

Physical analysis, training data synthesis, and training are of high memory and runtime complexity and are executed on the central training computer which offers sufficient performance. The result of the training (weights/parameters of the neural network) is then distributed to one or more local computing units, which are located in the local network of one or more robots. The camera is also connected to the local computing units during operation. The robot now transmits a message via the local network to trigger image acquisition and evaluation. The local computing unit responds with a gripping position. If more than one object is localized, the system prioritizes the gripping positions according to certain criteria such as accessibility, efficiency, etc.

As already indicated, image analysis essentially consists of two steps:
1. Evaluation of a neural network,
2. Refining the pose estimate from the output of the neural network with a modified registration algorithm.

Step 1 is often not accurate enough to perform the grip due to a lack of real training data. Step 2, on the other hand, provides very accurate results, but requires sufficient initialization by step 1. The disadvantages of both steps can be mutually compensated by the following procedure: In a bootstrapping phase, the robot first localizes (and grasps) parts under simpler environmental conditions, e.g., with the parts spread out on a plane instead of overlapping each other in a box. Under these circumstances, the purely synthetically trained network is sufficient for initializing the registration algorithm. The images of the bootstrapping phase can be annotated with the exact result from step 2 and transferred as a real training data set to the central training computer, where an optimization of the neural network is performed and transferred back to the local computing unit. This process can be continued iteratively, even if the system is already operating in its target environment (e.g., the box), in order to further increase accuracy/reliability.

The central training computer can be one or more virtual machines in a public or private cloud, or just a single powerful PC in the user's network. It forms a cluster (even in limit case of a single instance) whose elements communicate with each other via a network. A number of microservices are executed on the central training computer using orchestration software (e.g., Kubernetes), including services for data storage, geometric analysis of CAD models, data synthesis, and the training of neural networks (see below). The central training computer communicates with one or more local computing units via a WAN (e.g. the internet).

A characteristic feature of the local computing unit is that it is always connected to one or more robot controllers RC via a local network. The connection to the central training computer via the WAN, on the other hand, may be interrupted temporarily without disrupting the operation of the overall system. Like the central computer, the local computing unit can consist of one or more instances (VMs, PCs, industrial PCs, embedded systems) that form a (Kubernetes) cluster. Here, too, the entire software is executed as microservices in the form of containers.

The camera is at least capable of capturing three-dimensional images of the scene, but can also capture intensity images in the visible or infrared spectrum. A three-dimensional image consists of elements (pixels)to which the distance or depth of the respective depicted scene point is assigned. The procedure for determining the depth information (time-of-flight measurement, fringe projection) is irrelevant for the method described here. It is also independent of the choice of manufacturer. In line with the Plug & Play concept familiar from the consumer sector, the local processing unit downloads a suitable driver from the central training computer and executes it automatically as soon as a known camera is connected.

The robot is preferably a standard six-axis industrial robot, but simpler programmable manipulators, such as one or more combined linear units, can also be used. The choice of manufacturer is not relevant as long as the robot controller can communicate with the local computing unit via the network on the transport layer (OSI layer 4). Differences in the communication protocol (OSI layers 5-7) of different manufacturers are compensated for by a special translation microservice on the local computing unit. The robot is equipped with a preferably generic gripping tool such as a vacuum suction cup or a finger gripper. However, special grippers equipped with additional, e.g., tactile, sensors or adapted to the geometry of the object to create a form fit when gripping are also conceivable.

The following input data is available for the synthesis algorithm:
A polygonal geometric model of the object (e.g., a triangular mesh);
Unit of measurement of the 3D model;
Projection properties of the camera (in particular focal length, main point shift, radial distortion);
Relative position/orientation of the camera to a plane on which the objects themselves or a container/box holding the objects are/will be distributed/placed;
One or more grips, i.e., possible positions/orientations of a suitable gripper relative to the coordinate system of the 3D model, and optionally:
optionally a 3D model of the box used;
optionally the density or density distribution of the object.

This data is transmitted by the user to the central training computer either via a website or an app together with metadata about the product/object to be recognized (name, customer, article number, etc.).

Object recognition is based on the following kinematic model: We initially assume that all objects lie on a plane P. This restrictive assumption can later be softened for the removal from a box (see below). The position of an object relative to the local coordinate system of this plane is determined by means of a Euclidean transformation (R, t) consisting of a
rotation matrix R∈SO (3) and a translation vector t∈R³

The localization of an object is therefore equivalent to a search in the infinite group of Euclidean transformations. However, the search space can be greatly restricted by the geometric/physical analysis of the component.

Due to the laws of physics, an object can only assume a finite, discrete number of orientations. A cube, for example, can only lie on one of its six sides on a plane. Its training should therefore be limited to these six states. In each of the stable orientations (positions), the object can also be rotated around the respective vertical axis. Overall, the orientation R results from a composition of the rotational part of the stable state Rᵢ and a rotation Rφ around the vertical axis, where i=1, . . . ,n denotes one of the stable states and φ∈R denotes the continuous angle of rotation.

The stable states Rᵢ are determined using a Monte Carlo method. This can be carried out as follows: The 3D model is placed in a physical simulation environment at a fixed distance above the plane and dropped. Optionally, the density distribution inside the model (or parts of it) can be specified. The simulation system solves the equations of motion of the falling object and its collisions with the ground plane. The process is repeated over a large number of randomly selected drop poses. A histogram is calculated for all final orientations modulo the rotation around the vertical axis. The maxima of this histogram correspond to the desired stable states. The sampling of the rotation group SO (3) when selecting the start orientation must be done with great care in order to avoid distortion of the estimation function (bias).

For each stable orientation Rᵢ, the position of the object relative to the coordinate system of the plane is also obtained. Assuming that the Z-axis of this coordinate system is orthogonal to the plane, the X and Y components of ti can be discarded. It is precisely these components that need to be determined during object localization. In practice, however, their values are also limited, either by the finite extent of the plane P or the camera's field of view. The Z component of ti is saved for further processing. It is used to place the object on the plane without gaps during the synthesis of the training data (see below).

The value range of the rotation angle φ can also be narrowed down further. Due to periodicity, it generally lies in the interval [0, 2π]. If there is rotational symmetry around the vertical axis, this interval becomes even smaller. In the extreme case of a cylinder standing on its base, it shrinks to a single value of 0. The geometric image of the cylinder is independent of its rotation around the vertical axis. It is easy to see that the range of possile values for a cube, for example, is [0, 0.5π].

As part of the procedure, the value range of φ is determined fully automatically as follows: In the simulation environment already described above, a series of top views is rendered (for each stable state) by varying the angle φ. By calculating the distance of each image from the first image of the series in terms of the L₂ norm, a scalar-valued function s over the angle of rotation is obtained. This is first adjusted by its mean value and transformed into the frequency domain using a fast Fourier transformation. The maximum of the Fourier transforms provide a necessary condition for the periodicity of the signal s. Only the presence of zeros of s at these frequency maxima is sufficient. To determine the maximum periodicity, the frequency maxima are treated in descending order.

For image synthesis (synthesis algorithm):

To ensure the generalization capability of the neural network, the reduced search space resulting from the geometric analysis must be scanned evenly. Only positions/orientations shown during training can be reliably recognized during operation.

In a computer graphics environment, the synthesis algorithm is used to place the local coordinate system of the 3D model at a distance t_{i,z}, from the plane for each stable state i, on a Cartesian grid with values between min tₓ and max tₓ or min t_{y} and max t_{y}. For each position on the plane, the rotation angle φ is also varied in the range determined during the analysis phase [minφ, maxφ]. Using a virtual camera whose projection properties match those of the real camera used in operation, a depth image is rendered from the discretized search space for each object position and orientation. Each image is provided with information about the position and orientation (state i, rotation matrix R R_{φi}, and lateral position (tₓ, t_{y}) on the plane) of the object it contains.

In addition to the information relevant for solving the detection task, real images captured during operation contain disturbances that can significantly impair detection accuracy. These can be divided into two categories:
1. Systematic errors, such as insufficient calibration of the relative position between camera and plane or the violation of model assumptions (e.g., unknown objects in the scene, parts in a box instead of disjointly on a plane).
2. Stochastic disturbances such as noise superimposed on the image signal.

The network can only learn invariance to nuisance factors if representative images are available in the training data set. Additional images are generated for each of the constellations described above, simulating various nuisance factors. In particular
1. Gaussian noise of different variances,
2. one or more decoy objects in the form of a cuboid are added to the image of a target object in order to improve the discriminative power of the network (i.e., reduce the number of false positives),
3. the target objects are rotated out of the plane by different angles, and
4. moved up- and downwards by several discrete steps in the normal direction of the plane.

It should be noted, however, that this so-called domain randomization approach (cf: Kleeberger, K., Bormann, R., Kraus, W. et al. A Survey on Learning-Based Robotic Grasping. Curr Robot Rep 1, 239-249, 2020) cannot fully capture all the disturbances that occur in the real world. Therefore, the basic idea of the solution described here is to provide the training with data from a real environment with as little effort as possible.

The operation of the system and the recording of real image data as post-training data is described below.

The following data is loaded to the local computing unit LCU for or before operation of the system:
1. Product metadata,
2. the (pre-)trained parameters of the neural network,
3. the 3D model and
4. grip data.

This data is stored in a (local) database as a result of synchronization (see above) before operation on the local computing unit LCU. Of all the products already trained, one (or several for when the network also performs classification, e.g., for sorting) is activated for operation (“armed”) via an HTTP request. This request can originate from an app/website, the robot controller RC or another superordinate instance (e.g., a PLC), possibly with the aid of a translation microservice (see above). All data assigned to the product and relevant for object recognition is loaded from the database into the main memory, including
the parameters of the neural network for rough localization
the 3D model for fine localization using ICP algorithm A2
a set of grips, i.e., physically possible positions/orientation of the gripper relative to the object, which were defined by the user for the product before operation, e.g., via the web interface.

The first batches of the product are spread out on the plane on which the target container will later rest during production. The parts are assumed to be disjoint from each other but may otherwise occur in all possible positions and orientations.

If there are no more recognized objects to be processed, the robot controller RC sends a signal to the local processing unit LCU. This triggers the recording of a depth image and, if a corresponding sensor is available, also the recording of a two-dimensional intensity image. All images are stored in the memory of the local computing unit and transmitted by the synchronization service to the central computing unit as soon as a network connection is established. Each stored image is given a unique identification number to be able to associate it with object detections.

Only the depth image is then initially evaluated by the activated neural network. Each object position detected (position, orientation and stable state) is added to a queue and prioritized according to the reliability of the estimate, which also comes from the neural network. A further service, in particular the modified ICP algorithm, processes this queue according to priority. In particular, it refines the initial position/orientation estimate by minimizing the error between the measured depth image and the depth image rendered using the 3D model using a variant of the Iterative Closest Point (ICP) algorithm. The result is the position/orientation of the 3D model relative to the camera's coordinate system. Among the loaded grips, each represented by a transformation between the gripper and object coordinate system, a kinematically possible and collision-free one is searched for, linked with the object transformation and then transformed into a reference coordinate system known to the robot as a result of hand-eye calibration.

Not every transformation obtained in this way necessarily leads to the execution of a real gripping motion. For safety reasons, further criteria must be fulfilled in order to rule out undesired motions or even collisions of the robot. Only if the ICP residual does not exceed a certain critical value, the grasp is placed in a second queue, this time prioritized according to the ICP residual.

The robot controller RC now obtains the next best grip from this queue via further network requests. From the retrieved gripping pose, the robot controller calculates and executes a linear change in the joint angles (point-to-point movement) or a Cartesian linear path on which the gripper reaches the target position free of obstacles. At the target position, the gripper is activated (e.g., by creating a vacuum, closing the gripper fingers, etc.) so that the work cycle can then be completed with the desired manipulation (e.g., insertion into a machine, placement on a pallet, etc.).

As soon as the robot has successfully gripped a part, it signals to the image processing system that the final position/orientation of the object relative to the camera can be stored as a “label” in a database on the local computing unit LCU under the identification number of the current image (of the current images if an intensity image was taken). These labels are also sent by the synchronization service to the central processing unit CTC.

The identification number can later be used to establish the link between image data and labels.

The process starts from the beginning with a new image acquisition as soon as the queue is empty and no more grips can be obtained.

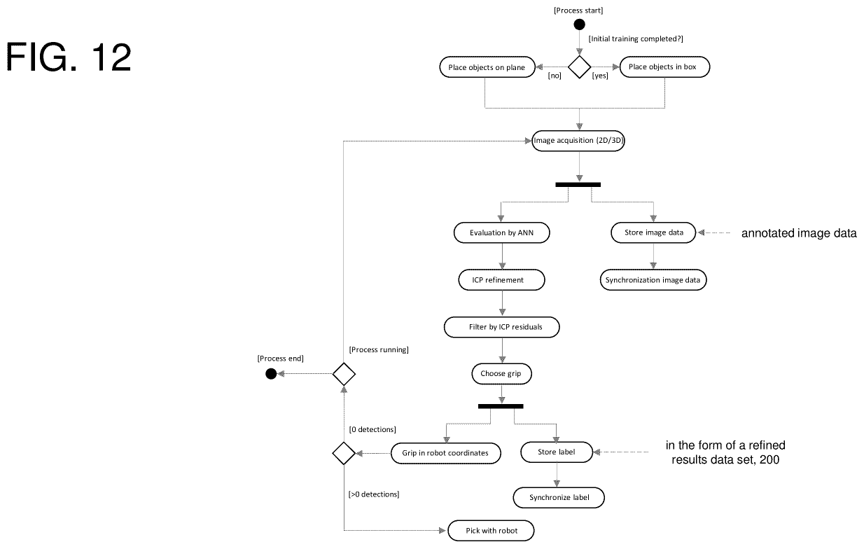

FIG. 12 shows a UML diagram for the operation/inference of the ANN neural network.

After the initial training process has been completed, the object to be grasped is placed in the field of view of the camera C either with (for example, on a plane, disjointly distributed) or without any restrictions (for example, a bulk in a box). An image capture is then triggered by the camera C. Once the image data has been captured by the camera C, two processes are initiated, which are shown in two parallel lines in FIG. 12. The left-hand side shows the main process, which is used to calculate the gripping instructions for the end-effector unit EE by evaluating the image data using the Votenet. The right branch shows the generation of post-training data. The annotation algorithm A3 can be used for this purpose. The annotation algorithm A3 is used to annotate the image data captured with the camera C. The annotation is performed on the basis of synthesized reference image data, which is calculated from the 3D model on the basis of the specific result data set (evaluation of the neural network). The annotated image data is then stored and transmitted to the central training computer CTC as post-training data.

In the left main branch, the neural network ANN is applied to the original image data captured by the camera C to determine the result data set. Subsequently, the modified ICP algorithm A2 can be applied to generate the refined result data set. The grasping instructions are calculated and/or the respective grasp for the object to be grasped is selected. The grip in robot coordinates can be output and, in particular, transmitted to the robot controller RC. The calculated labels, which are represented in the refined result data set, are stored and can be transmitted to the central training computer CTC for the purpose of post-training.

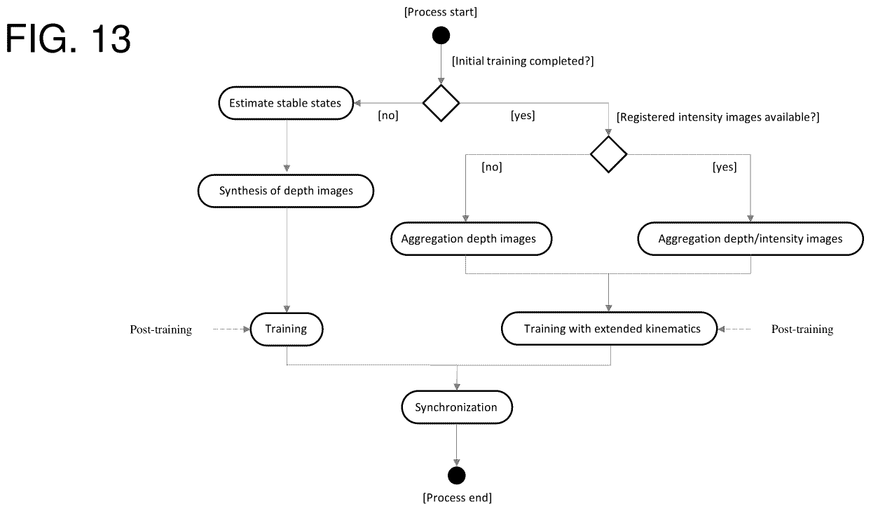

FIG. 13 shows a UML diagram for training the neural network ANN. As indicated in FIG. 13, in a preferred embodiment of the invention, the optical detection device and in particular the camera C can be designed to capture both depth images and intensity images of the object O to be gripped. The algorithm checks whether registered intensity images are present in order to carry out an aggregation of the captured depth images and the captured intensity images. The subsequent training can then be performed on the Votenet architecture with a 6-dimensional input layer (3 spatial coordinates, 3 color channels).

If no registered intensity images are available, the depth images are aggregated and saved.

The post-training executed on the central training computer CTC yields post-training parameters, which are distributed to the local computing unit LCU via the synchronization mechanism described above.

As soon as sufficient real training data has been collected, the neural network or A1 model can be refined by continuing the training. Before training, the individual images are aggregated into two separate files, the first of which contains the actual data for training and the second of which contains independent data that validates the recognition performance of the ANN neural network using metrics (validation data or reference data). Essentially, the metrics are the recognition rate, which evaluates four different outputs over the validation data set in different ways: 1. an existing object is also recognized (“true positives”). 2. an existing object is missed (“false negative”). 3. an irrelevant object is recognized (“false positive”). 4. an irrelevant object is ignored (“true negative”). The metrics differ from the loss function, which is used to optimize the weights over the training data set. Small values of the loss function generally do not imply good metrics, so the training success must always be evaluated based on both criteria.

The total number of real images should exceed the number of synthetically generated images from the first training run. If only depth data is available, the input data for the neural network, in particular the Votenet (see FIG. 10), consists of a set of points with 3 coordinates each. If images from an intensity camera are available and this is calibrated relative to the depth camera, the color/intensity of a point can be used as a further input feature. The training is initialized with the weights/parameters from the first run. From this initialization, the gradient descent is continued until it converges to a new stationary point. If necessary, individual layers are masked completely or temporarily, i.e., excluded from the gradient calculation.

The architecture of the network is slightly adapted for subsequent trainings: Rotations whose axis of rotation is tangential to the plane are no longer considered as disturbances (cf. above, the calculations for generating the object data based on physically plausible positions and orientations), but are also learned, firstly because it can be assumed that such constellations are contained in the real data. Secondly, the process runs after synchronization of the parameters with the local computing unit LCU in the target environment, where the parts are placed in any orientation, e.g. in a box.

While the process is running in the target environment, further post-training data can be recorded. This means that post-training can be continued iteratively until the recognition metric (relative to a sufficiently large real data set) does not improve any further.

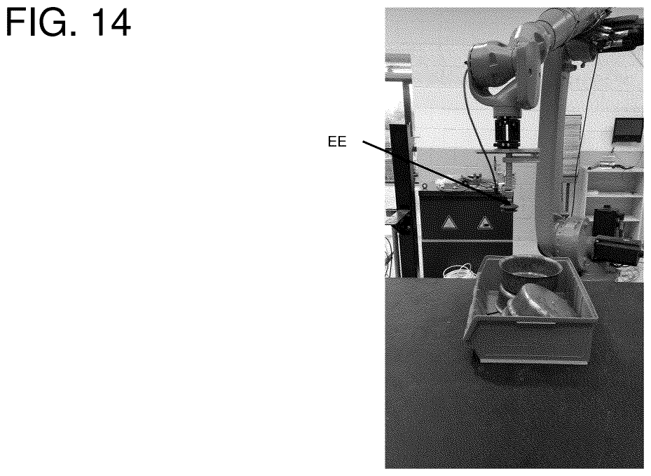

FIG. 14 shows an example of an end effector unit EE with 4 vacuum grippers, which are mounted on a robot arm and in this application are set up to remove a package (box) from a conveyor belt.

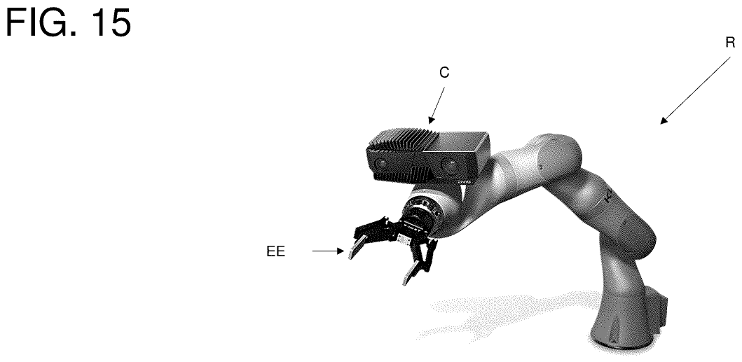

FIG. 15 shows another example of an end effector unit EE with a 2-finger gripper. It is obvious that the different types of gripping tools are suitable for different gripping tasks. Therefore, in a preferred embodiment of the invention, an identification data set is generated in response to the specific object type detected on the local computing unit LCU (here, for example, individual screws or nails) in order to select the type of gripper for performing the respective gripping task from a set of grippers. Only then can the gripper type-specific gripping instructions be calculated with the position information. This is usually done on the robot controller RC in response to the specific object type.

Finally, it should be pointed out that the description of the invention and the examples of embodiments are not to be understood in a fundamentally restrictive manner with regard to a specific physical realization of the invention. All features explained and shown in connection with individual embodiments of the invention can be provided in different combinations in the object according to the invention in order to realize their advantageous effects at the same time.

The sequence of process steps can be varied as far as technically possible.

The scope of protection of the present invention is given by the claims and is not limited by the features explained in the description or shown in the figures.

In particular, it is obvious to a person skilled in the art that the invention can be applied not only to the aforementioned examples of end effectors, but also to other handling tools of the robot which must be controlled by the calculated gripping instructions. Furthermore, the components of the local computing unit LCU and/or the central training computer CTC can be realized distributed on several physical-technical products.

1. Distributed system for controlling at least one robot (R) in a gripping task for gripping objects (O) of different object types which are arranged in a working area (CB, B, T) of the robot (R), comprising:
A central training computer (CTC), having a memory on which an instance of a neural network (ANN) is stored, wherein the central training computer (CTC) is intended for pre-training and for post-training of the neural network (ANN); wherein the neural network (ANN) is trained for object recognition and position detection, including detection of an orientation of the object (O), to calculate grasping instructions for an end effector unit (EE) of the robot (R) for grasping the object (O);
wherein the central training computer (CTC) is designed to receive an object type and
wherein the central training computer (CTC) is designed to perform a pre-training exclusively with synthetically generated object data which is generated by means of a geometric, object-type-specific 3D model of the object, and wherein, as a result of the pre-training, pre-training parameters of a pre-trained ANN are transmitted to at least one local processing unit (LCU) via a network interface (NIC), and wherein the central training computer (CTC) is further designed to continuously and cyclically perform a post-training of the neural network (ANN) and to transmit post-training parameters of a post-trained neural network (ANN) to at least one local processing unit (LCU) via the network interface (NIC) as a result of the post-training;
A set of local resources that interact via a local network (LAN):
The robot (R) with a robot controller (RC), a manipulator (M) and the end effector unit (EE), wherein the robot controller (RC) is intended for controlling the robot (R) and in particular its end effector unit (EE) for executing the gripping task for a respective object (O) of the respective object type;
An optical acquisition device (C) for capturing image data of objects in the working area (CB, B, T) of the robot (R);
at least one local processing unit (LCU) for interacting with the robot controller (RC),
the at least one local processing unit (LCU) being intended to store different instances of the neural network (ANN), receiving pre-training parameters and post-training parameters from the central training computer (CTC), in particular, in order to implement a pre-trained ANN which is continuously and cyclically replaced by a post-trained neural network (ANN) until a convergence criterion is fulfilled, and
wherein the pretrained or post-trained neural network (ANN) is applied in an inference phase on the local processing unit (LCU) determining a result data set (100) from the image data captured by the optical acquisition device (C), which is used to calculate the gripping instructions for the end effector unit (EE) for gripping the object (O) and to transmit these to the robot controller (RC) for execution;
wherein a modified Iterative Closest Point, ICP, algorithm (A2) is executed on the local processing unit (LCU), which firstly takes as input data the image data of the optical acquisition device (C) which has been fed to the implemented neural network (ANN) for application, and, secondly, reference image data and compares them with each other in order to minimize errors and to generate a refined result data set (200), the reference image data being a synthesized, rendered image which is rendered based on the result data set (100) determined by the neural network (ANN) and the 3D model;
and whereby the image data captured with the optical acquisition device (C) and the refined result data set (200) serves as a post-training data set and is transmitted to the central training computer (CTC) for the purpose of post-training;
The network interface (NIC) for data exchange between the central training computer (CTC) and the set of local processing units (LRE), whereby the data exchange takes place via an asynchronous protocol.

2. The system according to claim 1, wherein the network interface serves to transmit parameters for instantiating the pre-trained or post-trained neural network (ANN) from the central training computer (CTC) to the at least one local processing unit (LCU), and/or wherein the network interface (NIC) serves to transmitting the image data captured with the optical acquisition device (C) and the refined result data set (200) generated on the at least one local processing unit (LCU) to the central training computer (CTC) for post-training and/or wherein the network interface (NIC) serves to load the geometric, object-type-specific 3D model on the local processing unit (LCU).

3. System according to one of the preceding claims, in which annotated post-training data are generated on the local processing unit (LCU) from the image data acquired locally with the optical acquisition device (C) and fed to the neural network (ANN) and synthesized reference image data by means of an annotation algorithm (A3), which are transmitted to the central training computer (CTC) for the purpose of post-training, the synthesized reference image data being a synthesized, rendered image which is rendered based on the result data set (100) determined by the neural network (ANN) and the the 3D model.

4. System according to one of the preceding claims, wherein the system comprises a user interface (UI) which is intended to provide at least one selection field in order to determine an object type of the objects (O) to be grasped and wherein the determined object type is transmitted to the central training computer (CTC), so that the central training computer (CTC), in response to the determined object type, loads the object-type-specific 3D model from a model storage (MEM-M) in order to synthesize object-type-specific images in all physically plausible positions and/or orientations by means of a synthesis algorithm (A1), which serve as the basis for the pre-training of the neural network (ANN).

5. The system according to any one of the preceding claims, wherein the neural network (ANN) has a Votenet architecture comprising three modules, firstly, a backbone for learning local features, secondly, an evaluation module for evaluating and/or accumulating the individual feature vectors, and thirdly, a conversion module intended to convert a result of the accumulation into object detections.

6. The system according to any one of the preceding claims, wherein the network interface (NIC) facilitates synchronization using a message broker implemented as a microservice.

7. System according to one of the preceding claims, in which the data exchange between the local resources and the central training computer (CTC) takes place exclusively via the local processing unit (LCU), which serves as a gateway.

8. The system according to any one of the preceding claims, wherein the grasping instructions comprise an identification data set used to identify at least one end effector suitable for the object from a set of end effectors of the end effector unit (EE).

9. A system according to any one of the preceding claims, wherein the optical acquisition device is a device for capturing depth images and optionally for capturing intensity images in the visible or infrared spectrum.

10. A system according to the immediately preceding claim, wherein the computed grasping instructions can be visualized by showing a virtual scene of the gripper grasping the object, the calculated visualization of the grasping instructions being output on a user interface.

11. The system according to any one of the preceding claims, wherein the post-training of the neural network (ANN) is performed iteratively and cyclically following a transmission of post-training data in the form of refined result data sets comprising image data acquired locally by the optical acquisition device, which are automatically annotated and which have been transmitted from the local processing unit (LCU) to the central training computer (CTC).

12. The system according to any one of the preceding claims, wherein a post-training data set for post-training the neural network (ANN) is gradually and continuously expanded by image data acquired by sensors in the vicinity of the robot.

13. An operating method for operating a system according to any one of the preceding claims, comprising the following method steps:
On the central training computer (CTC): Read in (S1) an object type;
On the central training computer (CTC): Access (S2) a model storage (MEM-M) in order to load the 3D model, in particular CAD model, assigned to the selected object type and generate synthetic object data from it (S3) and use it for the purpose of pre-training;
On the central training computer (CTC): Pre-training (S4) of a neural network (ANN) with the generated synthetic object data;
On the central training computer (CTC): Provisioning (S5) of pre-training parameters;
On the central training computer (CTC): Transmission (S6) of the pre-training parameters via the network interface (NIC) to at least one local processing unit (LCU);
On the at least one local processing unit (LCU): reading (S7) pre-training parameters or post-training parameters of a pre-trained or post-trained neural network (ANN) via the network interface (NIC) in order to implement (S8) the pre-trained or post-trained neural network (ANN);
On the at least one local processing unit (LCU): Acquisition (S9) of image data;
On the at least one local processing unit (LCU): applying (S10) the pre-trained or post-trained neural network (ANN) with the acquired image data to determine (S11) the result dataset (100);
On the at least one local processing unit (LCU): executing (S12) a modified ICP algorithm (A2) which, as input data, firstly evaluates and compares the image data of the optical acquisition device (C) which have been supplied to the implemented neural network (ANN) for application and, secondly, reference image data, to minimize alignment errors and to generate (S13) a refined result data set (200), wherein the reference image data is a synthesized, rendered image which is rendered based on the result data set (100) determined by the neural network (ANN) and the 3D model;
On the at least one local processing unit (LCU): calculating (S14) gripping instructions for the end effector unit (EE) of the robot (R) based on the generated refined result data set (200);
On the at least one local processing unit (LCU): Data exchange (S15) with the robot controller (RC) for controlling the end effector unit (EE) of the robot (R) with the generated gripping instructions;
On the at least one local processing unit (LCU): generating (S16) post-training data, wherein the refined result data set (200) serves as the post-training data set and is transmitted (S17) to the central training computer (CTC) for the purpose of post-training;
On the central training computer (CTC): acquisition (S18) of the post-training data via the network interface (NIC), the post-training data comprising the labeled real image data acquired with the optical acquisition device (C);
On the central training computer (CTC): Continuous and cyclical retraining (S19) of the neural network (ANN) with the recorded retraining data until a convergence criterion is fulfilled for the provision (S20) of post-training parameters;
On the central training computer (CTC): Transmission (S21) of the post-training parameters via the network interface (NIC) to at least one local processing unit (LCU).

14. A method for operating a central training computer (CTC) in a system according to any one of the preceding claims 1 to 12, comprising the following method steps:
Reading in (S1) an object type;
Accessing (S2) the model storage (MEM-M) in order to load the 3D model, in particular the CAD model, assigned to the detected object type and to generate synthetic object data from it (S3) and use it for the purpose of pre-training;
Pre-training (S4) of a neural network (ANN) with the generated synthetic object data, which serve as pre-training data, to provide (S5) pre-training parameters;
Transmission (S6) of the pre-training parameters via the network interface (NIC) to the at least one local processing unit (LCU);
Retrieval (S18) of post-training data via the network interface (NIC), wherein the post-training data comprises a refined result data set (200) based on image data acquired with the optical acquisition device (C), which is annotated in an automatic process;
Continuous and cyclical retraining (S19) of the neural network (ANN) with the acquired retraining data until a convergence criterion is fulfilled to provide (S20) retraining parameters;
Transmission (S21) of the post-training parameters via the network interface (NIC) to the at least one local processing unit (LCU).

15. Central operating method according to the immediately preceding method claim, in which the steps of acquiring (S18) post-training data, post-training (S19), providing (S20) and transmitting (S21) the post-training parameters are carried out iteratively on the basis of newly acquired post-training data.

16. A local operating method for operating a local processing unit (LCU) in a system according to any one of the preceding claims 1 to 12, comprising:
Reading (S7) of pre-training parameters or post-training parameters of a pre-trained or post-trained ANN via the network interface (NIC) in order to implement (S8) the pre-trained or post-trained neural network (ANN);
Capturing (S9) of image data with the optical capture device (C) of the objects in the working area (CB, B, T) of the robot (R);
Applying (S10) the pre-trained or post-trained neural network (ANN) to the captured image data to determine (S11) the respective result data set (100) for the objects depicted in the image data;
Executing (S12) a modified Iterative Closest Point (ICP) algorithm (A2) which evaluates and compares as input data, firstly, the image data of the optical acquisition device (C) supplied to the implemented neural network (ANN) for evaluation and, secondly, reference image data, to minimize alignment errors and to generate (S13) a refined result data set (200), wherein the reference image data is a synthesized image which is rendered based on the result data set (100) determined by the neural network (ANN) and the 3D model;
Calculating (S14) gripping instructions for application on the end effector unit (EE) of the robot (R) based on the generated refined result data set (200);
Data exchange (S15) with the robot controller (RC) to control the end effector unit (EE) of the robot (R) with the generated gripping instructions;
generating (S16) post-training data, wherein the generated refined result data set (200) serves as a post-training data set and is transmitted (S17) to the central training computer (CTC) for the purpose of post-training.

17. A local operating method according to the immediately preceding claim, wherein the acquisition of the image data for the respective object is triggered before the g instructions for gripping the object are executed.

18. Local operating method according to one of claims 16 or 17, in which, when using the pre-trained neural network (ANN) in a pre-training phase, the objects are arranged under certain simplifying assumptions, in particular on a plane and disjointly in the working area (CB, B, T), and in which, when using the post-trained neural network (ANN), the objects are arranged in the working area (FB, B, T) without adhering to any simplifying assumptions.

19. A central training computer (CTC) in a distributed system according to claims 1 to 12, comprising a storage in which an instance of a neural network (ANN) is stored, wherein the central training computer (CTC) is intended for pre-training and for post-training of the neural network (ANN), which is trained for object recognition and for position detection, including detection of an orientation of the object (O), in order to calculate gripping instructions for an end effector unit (EE) of the robot (R) for gripping the respective object (O);
where the central training computer (CTC) is designed to read in an object type, and
wherein the central training computer (CTC) has an interface to a model storage (MEM-M), in which a geometric 3D model of the objects of the object type is stored for a respective object type, and
wherein the central training computer (CTC) is designed to perform a pre-training exclusively with synthetically generated pre-training data, which are generated by means of the geometric, object-type-specific 3D model of the objects of the specifief type, and wherein, as a result of the pre-training, pre-training parameters of a pre-trained neural network (ANN) are transmitted via a network interface (NIC) to at least one local processing unit (LCU), and
wherein the central training computer (CTC) is further designed to continuously and cyclically perform a post-training of the pre-trained neural network (ANN) on the basis of post-training data and to transmit post-training parameters of a post-trained neural network (ANN) via the network interface (NIC) to the at least one local processing unit (LCU) as a result of the post-training.

20. Local computing unit (LCU) in a distributed system according to claims 1 to 12, wherein the local computing unit (LCU) is intended for data exchange with a controller (RC) of the robot (R) for controlling the robot (R) and in particular its end effector unit (EE) for executing the gripping task for one object (O) at a time, and
wherein the local processing unit (LCU) is intended to store different instances of the neural network (ANN), in that the local processing unit (LCU) is intended to receive pre-training parameters and post-training parameters from the central training computer (CTC), in particular, to implement a pre-trained neural network (ANN) which is continuously and cyclically replaced by a post-trained neural network (ANN) until a convergence criterion is satisfied, and
wherein the pretrained or post-trained neural network (ANN) is applied in an inference phase by determining a result data set (100) for the image data captured by the optical capture device (C),
and wherein a modified Iterative Closest Point, ICP, algorithm (A2) is executed which evaluates and compares as input data, firstly, the image data of the optical acquisition device (C) supplied to the implemented neural network (ANN) for evaluation and, secondly, reference image data to minimize alignment errors and to generate a refined result data set (200), wherein the reference image data is a synthesized image which is rendered based on the result data set (100) determined by the neural network (ANN) and the 3D model, and wherein the refined result data set (200) serves as a basis for calculating the gripping instructions for the end effector unit (EE) for gripping the object (O) and transmitting these to the robot controller (RC) of the robot (R) for executing the gripping task.

21. The local processing unit (LCU) according to the immediately preceding claim, wherein the local processing unit (LCU) comprises a graphics processing unit (GPU) used to evaluate the neural network (ANN).
